(19) United States
(12) Patent Application Publication
(10) Pub. No.: US 2018/0254154 A1
(43) Pub. Date: Sep. 6, 2018

(54) PANEL-TYPE CONTROL BUTTON

(71) Applicant: Qingdao GoerTek Technology Co., Ltd., Qingdao (CN)

(72) Inventor: Geng LI, Qingdao (CN)

(73) Assignee: Qingdao GoerTek Technology Co., Ltd., Qingdao (CN)

(21) Appl. No.: 15/754,045

(22) PCT Filed: May 25, 2016
(86) PCT No.: PCT/CN2016/083319

§ 371 Date: Feb. 21, 2018

(30) Foreign Application Priority Data
Sep. 2, 2015 (CN) 201510554886.9

(51) Int. Cl. H01H 13/10; H01H 13/14; H01H 13/705; H01H 3/12

(52) U.S. Cl. CPC H01H 13/10; H01H 3/12; H01H 13/705; H01H 13/14

(57) ABSTRACT

A panel-type control button, including: a press key base, a press key panel, a switch board and a springback soft key. The press key panel is snap-fitted on top of the press key base, and one end of the press key panel is rotatably mounted at one end of the press key base. The switch board is located below the press key base, and is provided thereon with a switch mechanism. The springback soft key is located above the switch mechanism of the switch board. When the press key panel is pressed, the press key panel comes into contact with the springback soft key and triggers the switch mechanism on the switch board, and further controls the opening and closing of the switch mechanism. The springback soft key provides a springback force for the press key panel to reset.

### CROSS REFERENCE TO RELATED APPLICATIONS

This application is a National Stage entry of International Application No. PCT/CN2016/083319, filed on May 25, 2016, which claims priority to Chinese Patent Application No. 201510554886.9, filed on Sep. 2, 2015. The disclosure of the priority applications are hereby incorporated in their entirety by reference.

### TECHNICAL FIELD

The present disclosure relates to the technical field of electro-mechanics, and particularly relates to a panel-type control button.

### BACKGROUND ART

Buttons, as a element commonly used for controlling electric appliances, are seen everywhere in daily use electronic products. They can be classified as plane type (such as mice and keyboards) and side type (such as control switches for electric lamps) according to the design of electronic products. However, traditional designs of electronic buttons for household appliances have disadvantages such as large action space and high cost.

### SUMMARY OF THE DISCLOSURE

In view of the above problems, the panel-type control button of the present disclosure is proposed to solve or partially solve the above problems. The panel-type control button according to the present disclosure can be simultaneously applied to the front face and the sidewalls of electronic products and synchronously realize the action of automatic resetting, and has advantages of small action space, full mechanical transmission, low cost, etc.

In order to achieve the above objects, the technical solutions of the present disclosure are as follows.

The present disclosure provides a panel-type control button, wherein the panel-type control button comprises: a press key base, a press key panel, a switch board and a springback soft key;

the press key panel is snap-fitted on top of the press key base, and one end of the press key panel is rotatably mounted at one end of the press key base;

the switch board is located below the press key base, and the switch board is provided thereon with a printed circuit board and a switch mechanism;

the springback soft key is located above the switch mechanism of the switch board; and

when the press key panel is pressed, the press key panel comes into contact with the springback soft key and triggers the switch mechanism on the switch board, and further controls the opening and closing of the switch mechanism; and the springback soft key provides a springback force for the press key panel to reset.

Optionally, the press key base comprises a rotation shaft and a bevel;

the bevel and a plane where a bottom surface of the press key base is located form a certain angle;

the rotation shaft is located on top of the bevel, and is fixed on the press key base; and the rotation shaft is above the plane where the bottom surface of the press key base is located; and

the bevel is provided thereon with a clipping hole and a boss relief hole.

Optionally, one surface of the press key panel is provided with a first buckle, a boss and a second buckle, and the second buckle is provided thereon with a rotation shaft groove;

the other surface of the press key panel is provided with a protrusion, a position of the protrusion corresponds to a position of the boss, and when the protrusion is pressed, the boss moves downwardly;

the first buckle and the clipping hole on the press key base match and have corresponding positions, and the first buckle is snap-fitted in the clipping hole and is above the clipping hole by a certain distance;

the second buckle and the rotation shaft on the press key base match and have corresponding positions, and the second buckle is rotatably mounted on the rotation shaft via the rotation shaft groove; and

the boss and the boss relief hole on the press key base match, the boss passes through the boss relief hole and is above the boss relief hole by a certain distance, and when the boss moves downwardly, the boss comes into contact with the springback soft key.

Optionally, the press key base is further provided thereon with a third buckle and a fourth buckle; the third buckle and the fourth buckle are for mounting the panel-type control button on an electronic product.

Optionally, the number of each of the rotation shaft, the first buckle, the second buckle, the third buckle and/or the fourth buckle is at least one.

Optionally, the switch board is further provided thereon with a position locking hole; and

the position locking hole is for fixing the printed circuit board on the switch board.

Optionally, the springback soft key is provided thereon with a springback soft key contact point; and

when the press key panel is pressed, the springback soft key contact point comes into contact with the switch mechanism on the switch board and triggers the switch mechanism.

Optionally, the material of the springback soft key is silicone pad.

Optionally, the springback soft key is a spring or an elastic sheet.

The advantageous effects of the present disclosure are as follows. The panel-type control button according to the present disclosure can be simultaneously applied to the front face and the sidewalls of electronic products and synchronously realize the action of automatic resetting. The bevel and the rotation shaft that are provided on the press key base of the panel-type control button bring the present disclosure the characteristics such as small action space, full mechanical transmission, low cost, being simple and easy to assemble, etc, and thus make it superior to traditional designs of electronic buttons for household appliances.

### BRIEF DESCRIPTION OF THE DRAWINGS

FIG. 1 is a front view of a schematic structure diagram of a press key base of a panel-type control button according to an embodiment of the present disclosure;

FIG. 2 is a back view of a schematic structure diagram of a press key base of a panel-type control button according to an embodiment of the present disclosure;

FIG. 3 is a perspective view of a schematic structure diagram of a press key panel of a panel-type control button according to an embodiment of the present disclosure;

FIG. 4 is a back view of a schematic structure diagram of a press key panel of a panel-type control button according to an embodiment of the present disclosure when assembled on a press key base;

FIG. 5 is a front view of a schematic structure diagram of a press key panel of a panel-type control button according to an embodiment of the present disclosure when assembled on a press key base;

FIG. 6 is a front view of a schematic structure diagram of a panel-type control button according to an embodiment of the present disclosure after a press key panel, a press key base and a switch board are assembled;

FIG. 7 is a back view of a schematic structure diagram of a panel-type control button according to an embodiment of the present disclosure after a press key panel, a press key base and a switch board are assembled; and

FIG. 8 is a sectional view of a panel-type control button according to an embodiment of the present disclosure.

In the drawings: I is a press key base, II is a press key panel, III is a switch board, V is a springback soft key, 11 is a rotation shaft, 12 is a bevel, 21 is a clipping hole, 22 is a boss relief hole, 23 is a third buckle, 24 is a fourth buckle, 31 is a first buckle, 32 is a second buckle, 33 is a rotation shaft groove, 34 is a boss, 35 is a protrusion, 41 is a position locking hole, and 51 is a springback soft key contact point.

### DETAILED DESCRIPTION

In order to make the objects, technical solutions and advantages of the present disclosure clearer, the embodiments of the present disclosure will be described below in further detail in conjunction with the drawings.

The present disclosure provides a panel-type control button, which can be simultaneously applied to the front face and the sidewalls of electronic products, and has a small action space, is purely mechanically transmitted and the cost is low.

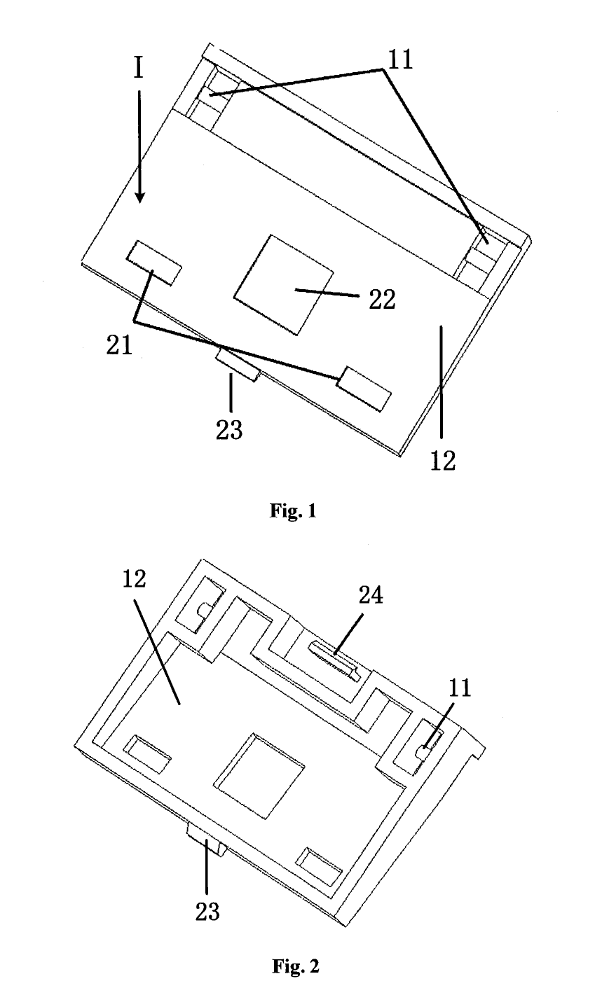

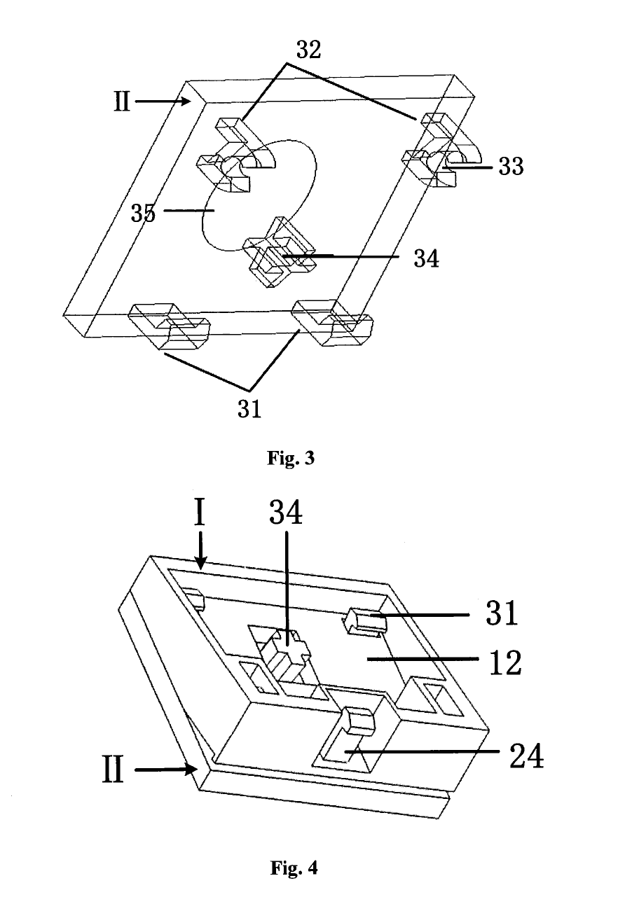

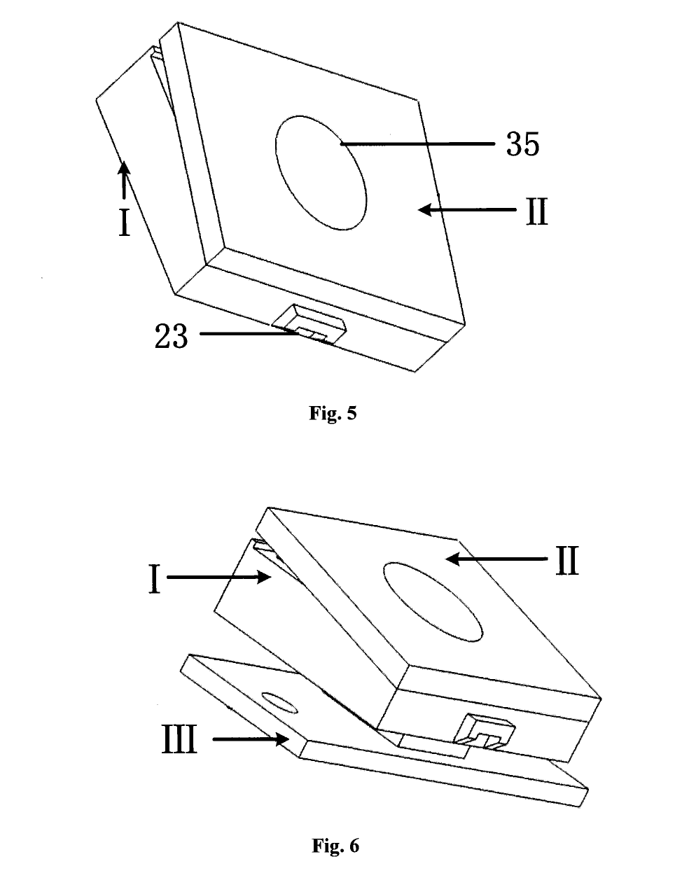

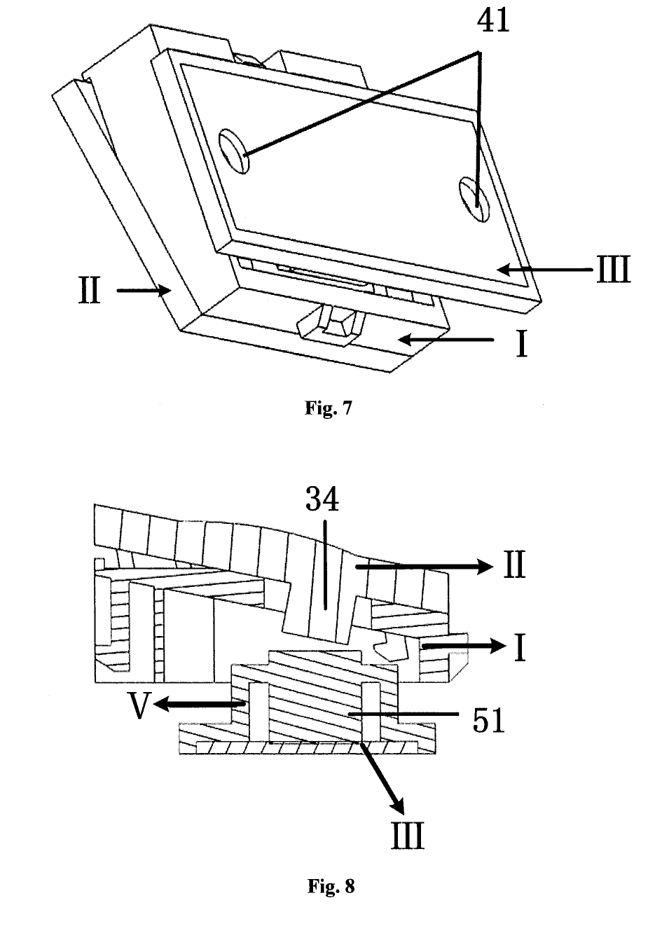

FIG. 1 is the front view of a schematic structure diagram of the press key base of the panel-type control button according to an embodiment of the present disclosure. FIG. 2 is the back view of a schematic structure diagram of the press key base of the panel-type control button according to an embodiment of the present disclosure. FIG. 3 is a schematic structure diagram of the press key panel of the panel-type control button according to an embodiment of the present disclosure. FIG. 4 is the back view of a schematic structure diagram of the press key panel of the panel-type control button according to an embodiment of the present disclosure when assembled on the press key base. FIG. 5 is the front view of a schematic structure diagram of the press key panel of the panel-type control button according to an embodiment of the present disclosure when assembled on the press key base. FIG. 6 is a front view of a schematic structure diagram of a panel-type control button according to an embodiment of the present disclosure after a press key panel, a press key base and a switch board are assembled. FIG. 7 is a back view of a schematic structure diagram of a panel-type control button according to an embodiment of the present disclosure after a press key panel, a press key base and a switch board are assembled. FIG. 8 is the sectional view of the panel-type control button according to an embodiment of the present disclosure.

As shown in FIGS. 1-8, a panel-type control button of an embodiment of the present disclosure comprises: a press key base I, a press key panel II, a switch board III and a springback soft key V. The press key panel II is snap-fitted on top of the press key base I (the direction far away from the front side of the press key base), and one end of the press key panel II is rotatably mounted at one end of the press key base I. The switch board III is located below the press key base I (the direction far away from the back side of the press key base). The switch board III is provided thereon with a printed circuit board and a switch mechanism (not shown in the figures). The switch mechanism is provided on the printed circuit board, and the springback soft key V is located above the switch mechanism of the s switch board III (the direction directly facing the back side of the press key base). When the press key panel II is pressed, the press key panel II comes into contact with the springback soft key V and triggers the switch mechanism on the switch board III, and further controls the opening and closing of the switch mechanism. The springback soft key V provides a springback force for the press key panel II to reset.

As shown in FIGS. 1 and 2, the press key base I comprises: a rotation shaft 11 and a bevel 12. The bevel 12 and the plane where the back surface of the press key base I is located form a certain angle, and the rotation shaft 11 is located on top of the bevel 12 and is fixed on the press key base I. The rotation shaft 11 is above the plane where the back surface of the press key base I is located. The bevel 12 is provided thereon with a clipping hole 21 and a boss relief hole 22.

As shown in FIG. 3, one surface of the press key panel II is provided with a first buckle 31, a boss 34 and a second buckle 32, and the second buckle 32 is provided with a rotation shaft groove 33 thereon. The other surface of the press key panel II is provided with a protrusion 35, and the position of the protrusion 35 corresponds to the position of the boss 34. The protrusion 35 can increase the tactile sensation when the user presses.

As shown in FIG. 4, the press key panel II is mounted on the front surface of the press key base I. The first buckle 31 and the clipping hole 21 on the press key base I match and have corresponding positions. The first buckle 31 is snap-fitted in the clipping hole 21 and is above the clipping hole 21 by a certain distance, so that when the user presses the press key panel II the press key panel II has a certain action space. In the embodiment of the present disclosure, the first buckle 31 is snap-fitted in the clipping hole 21 and is above the clipping hole 21 by 2 mm.

The second buckle 32 and the rotation shaft 11 on the press key base I match and have corresponding positions, and the second buckle 32 is rotatably mounted on the rotation shaft 11 via the rotation shaft groove 33. The boss 34 and the boss relief hole 22 on the press key base I match; the boss 34 passes through the boss relief hole 22 and is above the boss relief hole 22 by a certain distance. When the boss 34 moves downwardly, the boss 34 comes into contact with the springback soft key V. In the embodiment of the present disclosure, the boss 34 passes through the boss relief hole 22 and is above the boss relief hole 22 by 2 mm, so that when the press key panel II is pressed the boss 34 comes into contact with the corresponding springback soft key V.

As shown in FIG. 7, the springback soft key V is provided thereon with a springback soft key contact point 51; the springback soft key contact point 51 is located at the middle part of the springback soft key V, and corresponds to the position of the switch mechanism on the printed circuit board of the switch board III. When the protrusion 35 on the press key panel II is pressed, the press key panel II rotates about the rotation shaft 11, the boss 34 moves downwardly along with it (toward the direction of the switch board), the boss 34 comes into contact with the springback soft key V and presses downwardly the springback soft key V, the springback soft key V descends vertically, and the rotation traveling of the press key panel II switches to vertical traveling, and the action space is relatively small. Then, the springback soft key contact point 51 comes into contact with the switch mechanism on the switch board III and triggers the switch mechanism on the printed circuit board, thereby the circuit is turned on and control the turning-on and turning-off of an instruction or a circuit (such as a toilet flushing instruction). The springback soft key V provides a springback force to cause the boss 34 and the press key panel II to spring back and automatically reset, thereby the springback soft key contact point 51 and the switch mechanism on the switch board III are separated, and the circuit is turned off.

It can be seen from above that, the panel-type control button of the embodiment of the present disclosure is a switch mechanism transmitted and triggered purely mechanically, and its cost is relatively low.

It should be noted that, the material of the springback soft key V in the embodiment of the present disclosure is silicone pad. Optionally, the springback soft key V may also be a spring or an elastic sheet, as long as it can realize the function of automatic springback of the press key panel II.

As shown in FIG. 7, the switch board III is further provided thereon with a position locking hole 41, and the position locking hole 41 is for fixing the printed circuit board on the switch board III.

The press key base I is further provided thereon with a third buckle 23 and a fourth buckle 24. The third buckle 23 and the fourth buckle 24 are for mounting the panel-type control button on an electronic product. The number of each of the rotation shaft 11, the first buckle 31, the second buckle 32, the third buckle 23 and/or the fourth buckle 24 is at least one. In the embodiment of the present disclosure, the number of each of the rotation shaft 11, the first buckle 31 and the second buckle 32 is two, and the two are symmetrically distributed. The number of either of the third buckle 23 and the fourth buckle 24 is one, and they are located at the center positions of the edges of the press key panel II.

In conclusion, the panel-type control button according to the present disclosure has the following advantageous effects:

(1) it has a function of automatic resetting;

(2) it has a small action space;

(3) it has a simple structure and is easy to assemble; and

(4) it is purely mechanically transmitted and its cost is low.

The above description is merely preferable embodiments of the present disclosure, and is not used to limit the protection scope of the present disclosure. Any modifications, equivalent substitutions or improvements that are made within the spirit and principle of the present disclosure are all included in the protection scope of the present disclosure.

1. A panel-type control button, wherein the panel-type control button comprises: a press key base (I), a press key panel (II), a switch board (III) and a springback soft key (V);
the press key panel (II) is snap-fitted on top of the press key base (I), and one end of the press key panel (II) is rotatably mounted at one end of the press key base (I);
the switch board (III) is located below the press key base (I), and the switch board (III) is provided thereon with a printed circuit board and a switch mechanism;
the springback soft key (V) is located above the switch mechanism of the switch board (III); and
when the press key panel (II) is pressed, the press key panel (II) comes into contact with the springback soft key (V) and triggers the switch mechanism on the switch board (III), and further controls the opening and closing of the switch mechanism; and the springback soft key (V) provides a springback force for the press key panel (II) to reset;
wherein the press key base (I) comprises a rotation shaft (11) and a bevel (12);
the bevel (12) and a plane where a bottom surface of the press key base (I) is located form a certain angle;
the rotation shaft (11) is located on top of the bevel (12), and is fixed on the press key base (I); and the rotation shaft (11) is above the plane where the bottom surface of the press key base (I) is located; and
the bevel (12) is provided thereon with a clipping hole (21) and a boss relief hole (22).

2. (canceled)

3. The panel-type control button according to claim 1, wherein one surface of the press key panel (II) is provided with a first buckle (31), a boss (34) and a second buckle (32), and the second buckle (32) is provided thereon with a rotation shaft groove (33);
the other surface of the press key panel (II) is provided with a protrusion (35), a position of the protrusion (35) corresponds to a position of the boss (34), and when the protrusion (35) is pressed, the boss (34) moves downwardly;
the first buckle (31) and the clipping hole (21) on the press key base (I) match and have corresponding positions, and the first buckle (31) is snap-fitted in the clipping hole (21) and is above the clipping hole (21) by a certain distance;
the second buckle (32) and the rotation shaft (11) on the press key base (I) match and have corresponding positions, and the second buckle (32) is rotatably mounted on the rotation shaft (11) via the rotation shaft groove (33); and
the boss (34) and the boss relief hole (22) on the press key base (I) match, the boss (34) passes through the boss relief hole (22) and is above the boss relief hole (22) by a certain distance, and when the boss (34) moves downwardly, the boss (34) comes into contact with the springback soft key (V).

4. The panel-type control button according to claim 3, wherein the press key base (I) is further provided thereon with a third buckle (23) and a fourth buckle (24); the third buckle (23) and the fourth buckle (24) are for mounting the panel-type control button on an electronic product.

5. The panel-type control button according to claim 4, wherein the number of each of the rotation shaft (11), the first buckle (31), the second buckle (32), the third buckle (23) and/or the fourth buckle (24) is at least one.

6. The panel-type control button according to claim 1, wherein the switch board (III) is further provided thereon with a position locking hole (41); and
the position locking hole (41) is for fixing the printed circuit board on the switch board (III).

7. The panel-type control button according to claim 1, wherein the springback soft key (V) is provided thereon with a springback soft key contact point (51); and
when the press key panel (II) is pressed, the springback soft key contact point (51) comes into contact with the switch mechanism on the switch board (III) and triggers the switch mechanism.

8. The panel-type control button according to claim 7, wherein the material of the springback soft key (V) is silicone pad.

9. The panel-type control button according to claim 8, wherein the springback soft key (V) is a spring or an elastic sheet.
